(19) United States
(12) Patent Application Publication
(10) Pub. No.: US 2023/0022465 A1
(43) Pub. Date: Jan. 26, 2023

(54) CONTROLLERS, SYSTEMS, VEHICLES, AND METHODS FOR ACCELERATED CHARGING EVENTS

(71) Applicant: Rivian IP Holdings, LLC, Plymouth, MI (US)

(72) Inventors: Tyler Jennings Bennett, Long Beach, CA (US); Martin Hermez, West Bloomfield, MI (US)

(21) Appl. No.: 17/380,280

(22) Filed: Jul. 20, 2021

(51) Int. Cl. B60L 53/10; H02J 7/00; B60L 53/66

(52) U.S. Cl. CPC B60L 53/11; B60L 53/665; H02J 7/0048; B60L 2240/62; B60L 2240/64; B60L 2240/80

(57) ABSTRACT

Various disclosed embodiments include illustrative controller units, systems, vehicles, and methods. In an illustrative embodiment, a controller unit includes a communication component, a controller and a memory. The communication component is configured to communicate with a direct current charging device. The controller is configured to communicate with the communication component and the memory. The memory is configured to store computer-executable instructions configured to cause the controller to determine a target location, receive location information of a vehicle, receive state of charge information, determine a charging request in response to the target location, the location information of the vehicle, and the state of charge information, and send, via the communication component, the determined charging request to the direct current charging device connectable to the vehicle.

### INTRODUCTION

The present disclosure relates to direct current charging of a vehicle. The statements in this section merely provide background information related to the present disclosure and may not constitute prior art.

Due to numerous factors, such as thermal degradation, charging of battery packs of electric vehicles are controlled according to predefined charging curves. When an electric vehicle needs enough charge to get to a destination, a user’s home, or a next charging location, a direct current fast charging unit delivers power according to a predefined charging curve for the electric vehicle.

### BRIEF SUMMARY

Various disclosed embodiments include illustrative controller units, systems, vehicles, and methods.

In an illustrative embodiment, a controller unit includes a communication component, a controller and a memory. The communication component is configured to communicate with a direct current charging device. The controller is configured to communicate with the communication component and the memory. The memory is configured to store computer-executable instructions configured to cause the controller to determine a target location; receive location information of a vehicle; receive state of charge information; determine a charging request in response to the target location, the location information of the vehicle, and the state of charge information; and send, via the communication component, the determined charging request to the direct current charging device connectable to the vehicle.

In another illustrative embodiment, a system includes a location sensor, a battery sensor, and a controller unit. The controller unit includes a communication component, a controller, and a memory. The location sensor is configured to identify location of a vehicle. The battery sensor is configured to determine state of charge information of a battery. The controller unit is configured to communicate with the location sensor and the battery sensor. The communication component is configured to communicate with a direct current charging device. The controller is configured to communicate with the direct current charging device via the communication component. The memory is configured to communicate with the controller. The memory is configured to store computer-executable instructions configured to cause the controller to determine a target location; receive the identified location of the vehicle; receive the state of charge information; determine a charging request in response to the determined target location, the received location of the vehicle, and the received state of charge information; and send, via the communication component, the determined charging request to the direct current charging device connectable to the vehicle.

In another illustrative embodiment, a vehicle includes a location sensor, a battery, a battery sensor, and a controller that is configured to communicate with the location sensor and the battery sensor. The location sensor is configured to identify location of the vehicle. The battery sensor is configured to determine state of charge information of the battery. The controller unit includes a communication component, a controller, and a memory. The communication component is configured to communicate with an external device. The controller is configured to communicate with the external device via the communication component. The memory is configured to communicate with the controller and is configured to store computer-executable instructions configured to cause the controller to determine a target location, receive the location of the vehicle, receive the state of charge information, determine a charging request in response to the target location, the location of the vehicle, and the state of charge information, and send, via the communication component, the determined charging request to the external device connectable to the vehicle.

In another illustrative embodiment, a method includes determining a target location, receiving location information for a vehicle, receiving state of charge information, determining a charging request in response to the target location, the location information of the vehicle, and the state of charge information, and sending the determined charging request to a direct current fast charger unit connectable to the vehicle.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 is an illustration in partial schematic form of an illustrative vehicle in a charging scenario.

FIG. 2 is a block diagram of illustrative components used in direct current charging of a vehicle.

FIG. 3 is a graph of various charge cycles.

FIG. 4 is a flow diagram of an illustrative method for requesting charging of a vehicle.

FIG. 5 is a flow diagram of details of the method of FIG. 4.

Like reference symbols in the various drawings generally indicate like elements.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Various disclosed embodiments include illustrative controller units, systems, vehicles, and methods. As will be explained below, such embodiments can control a battery charging event and may help contribute to decreasing battery charging times.

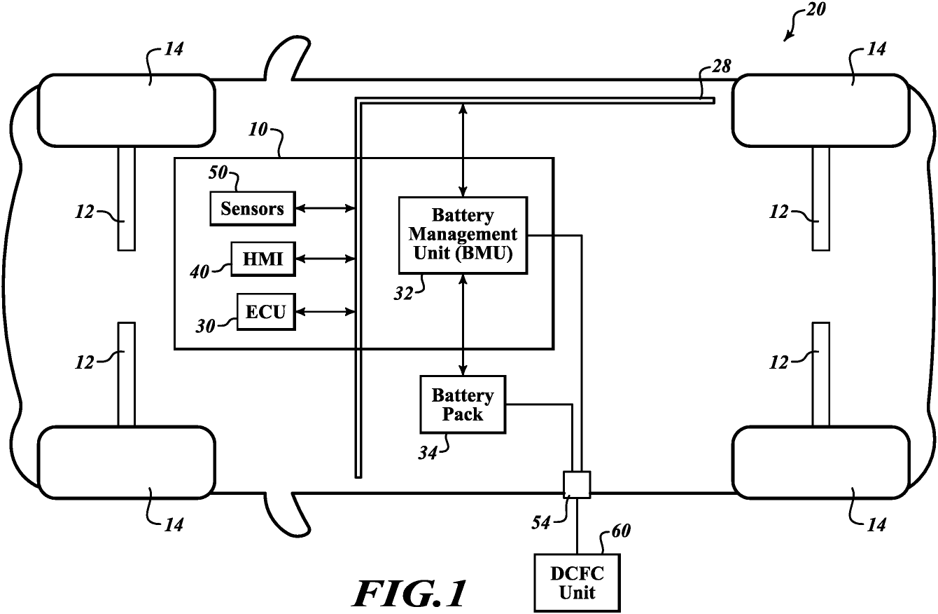

Referring now to FIG. 1, in various embodiments an illustrative vehicle 20 includes a system 10 for controlling a battery charging event, such as a direct current fast charging (DCFC) event. In various embodiments the vehicle 20 is an electric vehicle or a hybrid electric vehicle. The vehicle 20 includes a battery pack 34. The system 10 may include an electronics control unit (ECU) 30, a battery management unit (BMU) 32, a human-machine interface (HMI) 40, and a vehicle sensor(s) 50, all of which will be described in more detail below.

In various embodiments and given by way of example only and not of limitation, the battery pack 34 suitably includes high energy rechargeable batteries that store electrical charge, discharge electrical current upon request, and recharge via a charging port 54. The battery pack 34 may be structured in any desirable form, such as without limitation cylindrical, pouch, prismatic, massless, or other comparable forms. In various embodiments the battery pack 34 includes Li-ion batteries, such as without limitation Nickel Cobalt Aluminium, Lithium Manganese Cobalt, or Lithium Manganese Oxide batteries. However, other materials may be used that provide comparable recharging, energy density, and energy discharge capabilities.

Recharging of the battery pack 34 is performed according to a previously defined charging curves for use during DCFC events. As will be described in more detail below, in various embodiments charging curves are used by the system 10 to instruct a direct current fast charging (DCFC) unit 60 couplable to the battery pack 34 via the charging port 54. The charging curve used is selected such that the battery pack 34 avoids temperatures that may degrade the life of the battery pack 34 during DCFC events. The use of charging curves for DCFC events is well known in the art and no further explanation is necessary for a person of skill in the art to understand disclosed subject matter.

In various embodiments and given by way of example only and not of limitation, the battery pack 34 stores high voltage direct current (DC) electrical power and provides the high voltage DC electrical power to one or more inverters (not shown) that convert the high voltage DC electrical power to high voltage alternating current (AC) electrical power. The conversion of high voltage DC electrical power to high voltage AC electrical power and subsequent rotation of drive wheels by electrical motors is well known in the art and no further explanation is necessary for a person of skill in the art to understand disclosed subject matter. The high voltage AC electrical power is provided to one or more electrical motors (not shown) that are coupled to rotate one or more axles 12 which, in turn, are coupled to rotate two or four drive wheels 14. The conversion of high voltage DC electrical power to high voltage AC electrical power and subsequent rotation of drive wheels 14 by electrical motors is well known in the art and no further explanation is necessary for a person of skill in the art to understand disclosed subject matter.

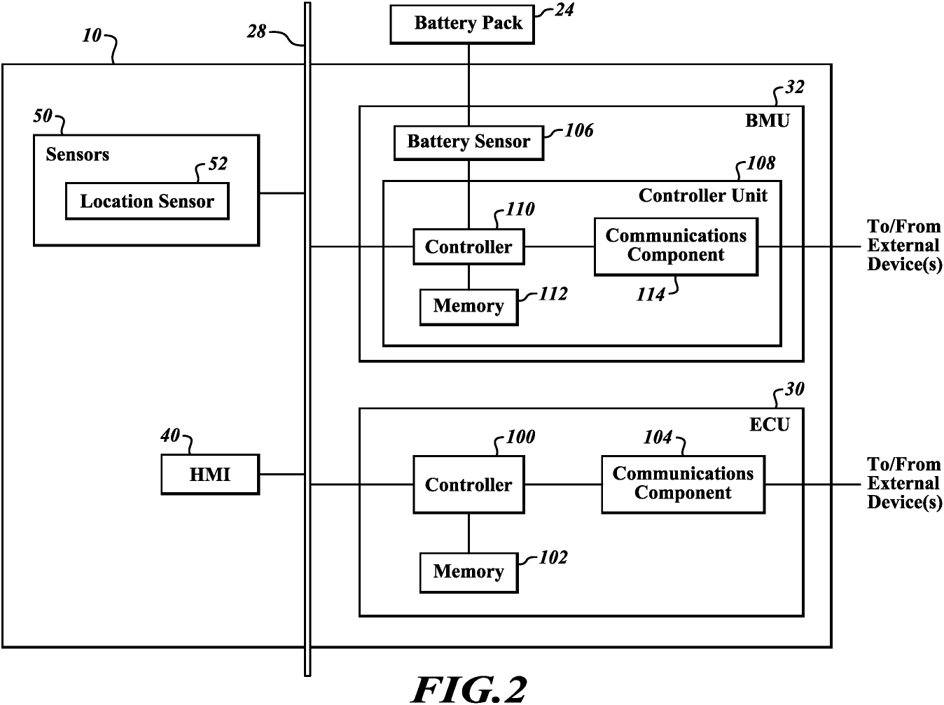

Referring additionally to FIG. 2, the system 10 includes a location sensor 52 (included as one of the vehicle sensors 50) and a battery sensor 106 and a controller unit 108 within the BMU 32. The controller unit 108 includes a communication component 114, a controller 110, and a memory 112. The location sensor 52 identifies location of the vehicle 20. The battery sensor 106 determines state of charge information of batteries in a battery pack 24. The controller unit 108 communicates with the location sensor 52 and the battery sensor 106. The communication component 114 communicates with the DCFC unit 60. The controller 110 communicates with external devices, e.g., the DCFC unit 60 via the communication component 114. The memory 112 stores computer-executable instructions configured to cause the controller to determine a target location; receive the identified location of the vehicle; receive the state of charge information; determine a charging request in response to the determined target location, the received location of the vehicle, and the received state of charge information; and send, via the communication component 114, the determined charging request to the DCFC unit 60 connectable to the vehicle 20.

The ECU 30 and the BMU 32 may communicate with numerous other vehicle components via a network bus 28, such as a controller area network (CAN) bus. Other network buses, such as a local area network (LAN) bus, a wide area network (WAN) bus, or a value-added network (VAN) bus, may also be used for enabling communication between the components connected to the network. The BMU 32 and the ECU 30 may communicate via the network bus 28 with the HMI 40, numerous vehicle sensors 50 including the location sensor 52, and each other.

In various embodiments and given by way of example only and not of limitation, a DC charging port 54 connects an external DCFC unit 60 directly to the battery pack 34 for receiving charging DC power. The BMU 32 communicates with the DCFC unit 60 wirelessly or through the DC charging port 54 to control DC power outputted by the DCFC unit 60. The DC charging port 54 allows for high DC voltage fast charging to occur. The DC charging port 54 may be a Combined Charging System (CCS), a CHAdeMO, or other charger types that allow for the transmission of high DC power (~350 kW) to directly charge batteries. DC fast charging connectors are well known in the art and no further explanation is necessary for a person of skill in the art to understand disclosed subject matter.

In various embodiments and given by way of example only and not of limitation, the DCFC unit 60 uses DC to directly charge the battery pack 34 without needing to go through an onboard AC-DC battery converter (not shown). The DCFC unit 60 receives AC power from an AC power source, such as without limitation the power grid, renewable energy sources, or the like and converts the AC power to a DC power level based on a handshake communication with the vehicle 20. DCFC units are well known in the art and no further explanation is necessary for a person of skill in the art to understand disclosed subject matter.

In various embodiments and given by way of example only and not of limitation, the location sensor 52 may include, without limitation, a global positioning system (GPS) device, a comparable position locating device, or an external device, such as a cell phone or computer having location determining capabilities such as triangulation or the like. The vehicle sensors 50 may also include wheel speed sensors, gyroscopes, accelerometers, light detection and ranging (LIDAR) devices, cameras, a rain light sensor, other weather sensors, or any other sensor as desired.

In various embodiments and given by way of example only and not of limitation, the HMI 40 may include mechanical buttons, voice actuation components/controls, gesture sensors, or switches or may include selectable graphical user interface features presented on a vehicle display device(s). The HMI 40 allows a vehicle operator to select from various pre-programmed modes of vehicle operation. One of the pre-programmed modes of vehicle operation include an altered/accelerated charging mode, described in more detail below.

In various embodiments and given by way of example only and not of limitation, the BMU 32 communicates with the battery pack 34 to determine battery status information. The BMU 32 receives battery information from the battery sensor 106. The battery information may include state of charge (SOC), temperature, voltage of battery cells, input/output current, coolant flow, or other values important to battery operations. The BMU 32 uses the battery information to control battery charging and battery thermal management and to communicate battery charging controls with other vehicle components via the network bus 28 or with an external device(s), such as the DCFC unit 60, another DC charging device, a vehicle, a diagnostic computer, or other comparable devices.

Referring additionally to FIG. 2, in various embodiments the ECU 30 may include a controller 100 (that is, a data processor) having a memory 102 (computer-readable media) configured to store computer-executable instructions configured to cause the controller 100 to perform a number of functions and a communication component 104. The computer-executable instructions are configured to cause the controller 100 to determine a next vehicle charging location (a target location) from data received from the vehicle sensors 50 and/or the HMI 40 via the network bus 28, or from external devices via the wired or wireless communication component 104. The ECU 30 sends the target location to the BMU 32 via the network bus 28.

In various embodiments, the BMU 32 may include a controller 110 (a data processor) having a memory 112 (computer-readable media) configured to store computer-executable instructions configured to cause the controller 110 to perform a number of functions. The computer-executable instructions are configured to cause the controller 110 to receive the target location the ECU 30 or the HMI 40 via the network bus 28, or an external device(s) via a wired or wireless communication component 114. The computer-executable instructions are configured to cause the controller 110 to receive the location information of the vehicle 20 from the location sensor 52 or the ECU 30 via the network bus 28, or an external device(s) via the communication component 114. The computer-executable instructions are configured to cause the controller 100 of the BMU 32 to determine a charging request in response to the determination of the target location, the vehicle location information, and the battery status information. The BMU 32 sends the charging request to the DCFC unit 60 via the communication component 114 or via the DC charging port 54.

In various embodiments and given by way of example only and not of limitation, the battery sensor 106 may estimate SOC by measuring the coulombs and current flowing in and out of the battery pack 34 under all operating conditions, and voltages of each cell in the battery pack 34. Additional data such as cell temperature, whether the cell is charging or discharging when the measurements were made, the cell age, and other relevant cell data may also be taken into consideration when estimating SOC. Various types of battery sensors are well known in the art and no further explanation is necessary for a person of skill in the art to understand disclosed subject matter.

In various embodiments and given by way of example only and not of limitation, the communication component 114 and the communication component 104 communicate with the DCFC unit 60 using a control pilot (CP) contact of the DC charging port 54 using high frequency pulsewidth modulated signals based on the standards DIN SPEC70121 and ISO/IEC 15118-series. Communication with DCFC units is well known in the art and no further explanation is necessary for a person of skill in the art to understand disclosed subject matter.

The BMU 32, upon execution of instructions stored in the memory 112, creates the charge request by altering a previously-stored charge curve in response to the target location, the location information of the vehicle, and battery pack SOC information. The previously-stored charge curve is selected/determined such that the battery pack 34 avoids temperatures and other physical transformations that may degrade the life of the battery pack 34 during DCFC events. Charge curves are determined by a complicated process of analyzing battery cell level capabilities and limits associated with battery life, such as, without limitations, temperature limits, cell analysis related to lithium plating and dendrite formation, and the like. The cell level capabilities and limits are then scaled to the pack level. A pack is a combination of many battery cells. Thermal capabilities/limits of the battery pack are also taken into consideration in determination of the charge curve. The battery sensor 106 determines SOC information of batteries in a battery pack 24. The BMU 32 uses the previously-stored charge curve and the SOC information to set the charge current. Techniques for charge curve determination are well known in the art and no further explanation is necessary for a person of skill in the art to understand disclosed subject matter.

The BMU 32, upon execution of instructions stored in the memory 112, includes information, such as, without limitation, a requested charge current value, from the altered previously-stored charge curve in the charge request. The BMU 32, upon execution of instructions stored in the memory 112, requests an alteration of the previously-stored charge curve. The instructions determine energy needed for a trip or route after a charging event has been completed. The determined energy may consider various factors, such as, without limitations, an identified route to next charging event, time to next charging event, and the like. The BMU 32 uses the SOC information, current battery pack temperature, and the determined energy needed in relation to the previously-stored charge curve to determine an optimized/minimized charge time. The optimized/minimized charge time results in an altered charge curve. In various embodiments, an optimization algorithm, such as, without limitations, a recursive algorithm, may be used to determine the optimized/minimized charge time. Optimization algorithms are well known in the art and no further explanation is necessary for a person of skill in the art to understand disclosed subject matter.

In various embodiments, the BMU 32, upon execution of instructions stored in the memory 112, may receive weather information, such as without limitation, temperature, humidity, precipitation, or comparable weather information from the HMI 40, an external source, via the communication components 114, and/or from the vehicle sensors 50. It can be appreciated that inclement weather may lead to slower driving times. As such, a greater amount of energy may be needed to travel to the target destination. A determination that more energy is needed affects the charge time optimization algorithm thus affecting the charge request or charging curve to meet the higher energy needs given the other factors, the SOC information, battery pack temperature, and the like. The BMU 32, upon execution of instructions stored in the memory 112, alters the previously-stored charge curve, essentially generates a new charge curve, in further response to the received weather information (the optimized charge time).

In various embodiments, the BMU 32, upon execution of instructions stored in the memory 112, may receive road conditions information and alters the previously-stored charge curve in further response to the received road conditions information. It can be appreciated that adverse road conditions may lead to slower driving times. As such, a greater amount of charge may be needed to travel to the target destination. The road conditions information may include traffic information and road status information. The road conditions information may be associated with a route associated with the vehicle location information and the target location.

In various embodiments, the BMU 32, upon execution of instructions stored in the memory 112, may receive route information and determines a location included in the received route information to be the target location. In various embodiments, the memory 102 of the ECU 30 may include a navigation module that when executed by the controller 100 creates a navigation route in response to user input received via the HMI 40 or a remotely connected device. The navigation module may also cause the ECU 30 to automatically create the navigation route using stored historical waypoint/destination information. The target location is chosen from a route waypoint and a route destination included in the received route information. The target location may include a home or a work address associated with the vehicle or an operator of the vehicle.

It will be appreciated that the functions described herein for the ECU 30 and the BMU 32 may be distributed between each other, to other data processing components of the vehicle 20, or to other devices that are in communication with components of the vehicle 20.

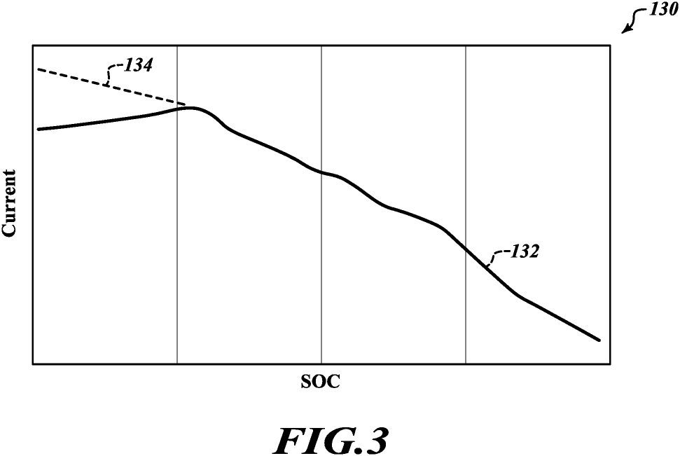

Referring additionally to FIG. 3, an illustrative current charging rate graph 130 includes unaltered and altered charge curves as described above. A previously-stored curve 132 is an unaltered previously defined charge curve. The previously-stored curve 132 is an unmodified charge curve previously defined to charge the battery pack 24. A 10 minute curve 134 is an altered curve having higher requested current values than the previously-stored curve 132. The 10 minute curve 134 is an example of a new charge curve generated based on all the factors (SOC, determined energy needed, and the like) entered into the charge time optimization algorithm. With regard to the 10 minute curve 134 the optimization determined that the quickest charge time to get the determined energy based on the SOC information, battery pack temperature is 10 minutes and that the charge curve is altered from the previously-stored curve 132 to accomplish the charging in 10 minutes. The 10 minute curve 134 may, for example, correspond to a scenario where the vehicle needs more charge at a shorter duration than the previously-stored charging curve. In some examples, this can be determined using a distance to the target location with or without additional information, such as, weather information. Heavy snow in the weather information may result in a greater energy need to get to the target location. It can be appreciated by one or ordinary skill in the art that the examples illustrated above are rough examples for three different charging time periods and that any time period that relates to the current state of charge and an amount of time determined to get to the target location may be used to generate an altered charge curve. The charge time optimization algorithm is a continuously dynamic process that produces a unique charge curve based on the needed mileage (and other info (weather)).

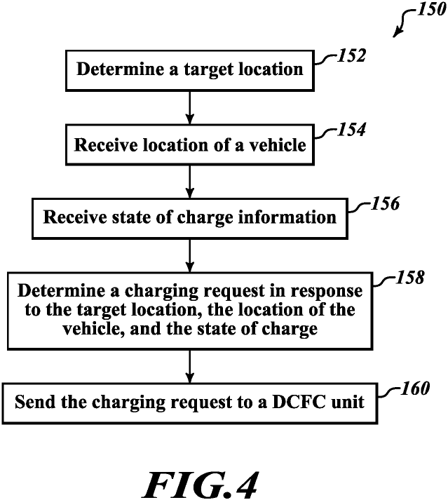

Referring additionally to FIG. 4, an illustrative process 150 may be performed for accelerating a DC charging event. At a block 152, a target location is determined. At a block 154, location information of a vehicle is received. At a block 156, battery SOC information is received. At a block 158, a charging request is determined in response to the target location, the location information of the vehicle, and the SOC information. At a block 160, the charging request is sent to a direct current fast charger unit connectable to the vehicle.

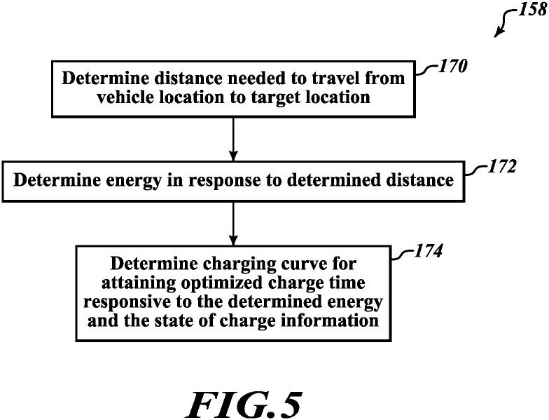

Referring additionally to FIG. 5, additional illustrative details will be explained regarding portions of the process 150. For example, in various embodiments the process performed at the block 158 (FIG. 4) may be expanded upon. In some such embodiments, at a block 170, distance needed to travel from the vehicle location to the target location is determined. At a block 172, energy (battery energy) is determined responsive to the determined distance. At a block 174, a charging curve for attaining an optimized charge time is determined responsive to the determined energy (distance) and the state of charge information. The optimized charge time forms at least part of the charging request. The charging curve is created or altered from the previously-defined charging curve in order to produce the optimized charge time and determined energy.

In some embodiments, the charging request may be determined by altering a previously-stored charge curve in response to the target location, the location information of the vehicle, and the SOC information. The charging request includes information from the altered previously-stored charge curve.

In some embodiments, the previously-stored charge curve may be altered by increasing a charging current value at a time interval of the charge curve.

In some embodiments, weather information may be received and the previously-stored charge curve may be altered in further response to the received weather information.

In some embodiments, road condition information may be received and the previously-stored charge curve may be altered in further response to the received road condition information. The road condition information may be chosen from traffic information and road status information.

In some embodiments, route information may be received and a location included in the route information may be determined to be the target location, the location being chosen from a route waypoint and a route destination. The target location may include a home address associated with the vehicle.

Those skilled in the art will recognize that at least a portion of the ECU 30, the BMU 36, the HMI 40, controllers, components, devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and application programs, one or more interactive devices (e.g., a touch pad, a touch screen, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

The term controller, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of controller (e.g., at a first time), as a second type of controller (e.g., at a second time, which may in some instances coincide with, overlap, or follow a first time), and/or as a third type of controller (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first controller that has a first purpose, then a second controller that has a second purpose and then, a third controller that has a third purpose, and so on. The transition of a reconfigurable and/or controllable component may occur in as little as a few nanoseconds, or may occur over a period of minutes, hours, or days.

In some such examples, at the time the controller is configured to carry out the second purpose, the controller may no longer be capable of carrying out that first purpose until it is reconfigured. A controller may switch between configurations as different components/modules in as little as a few nanoseconds. A controller may reconfigure on-the-fly, e.g., the reconfiguration of a controller from a first controller into a second controller may occur just as the second controller is needed. A controller may reconfigure in stages, e.g., portions of a first controller that are no longer needed may reconfigure into the second controller even before the first controller has finished its operation. Such reconfigurations may occur automatically, or may occur through prompting by an external source, whether that source is another component, an instruction, a signal, a condition, an external stimulus, or similar.

For example, a central processing unit or the like of a controller may, at various times, operate as a component/module for displaying graphics on a screen, a component/module for writing data to a storage medium, a component/module for receiving user input, and a component/module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple components/modules, the example includes the possibility that the same hardware may implement more than one of the recited components/modules, either contemporaneously or at discrete times or timings. The implementation of multiple components/modules, whether using more components/modules, fewer components/modules, or the same number of components/modules as the number of components/modules, is merely an implementation choice and does not generally affect the operation of the components/modules themselves. Accordingly, it should be understood that any recitation of multiple discrete components/modules in this disclosure includes implementations of those components/modules as any number of underlying components/modules, including, but not limited to, a single component/module that reconfigures itself over time to carry out the functions of multiple components/modules, and/or multiple components/modules that similarly reconfigure, and/or special purpose reconfigurable components/modules.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (for example “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software (e.g., a high-level computer program serving as a hardware specification) and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

What is claimed is:

1. A controller unit comprising:
a communication component configured to communicate with a direct current charging device;
a controller configured to communicate with the communication component; and
a memory configured to communicate with the controller, the memory configured to store computer-executable instructions configured to cause the controller to:
determine a target location;
receive location information of a vehicle;
receive state of charge information;
determine a charging request in response to the determined target location, the location information of the vehicle, and the state of charge information; and
send, via the communication component, the determined charging request to the direct current charging device connectable to the vehicle.

2. The controller unit of claim 1, wherein the memory is further configured to store computer-executable instructions configured to cause the controller to:
alter a previously-stored charge curve in response to the target location, the location information of the vehicle, and the state of charge information; and
include information from the altered previously-stored charge curve in the charge request.

3. The controller unit of claim 2, wherein the memory is further configured to store computer-executable instructions configured to cause the controller to:
increase a charging current value at a time interval of the previously-stored charge curve.

4. The controller unit of claim 2, wherein the memory is further configured to store computer-executable instructions configured to cause the controller to:
receive weather information; and
alter the previously-stored charge curve in further response to the received weather information.

5. The controller unit of claim 2, wherein the memory is further configured to store computer-executable instructions configured to cause the controller to:
receive road condition information; and
alter the previously-stored charge curve in further response to the received road condition information.

6. The controller unit of claim 5, wherein the road condition information is chosen from traffic information and road status information.

7. The controller unit of claim 1, wherein the memory is further configured to store computer-executable instructions configured to cause the controller to:
receive route information; and
determine a location included in the received route information to be the target location, the location being chosen from a route waypoint and a route destination.

8. The controller unit of claim 1, wherein the target location includes a home address associated with the vehicle.

9. A system comprising:
a location sensor configured to identify location of a vehicle;
a battery sensor configured to determine state of charge information of a battery; and
a controller unit configured to communicate with the location sensor and the battery sensor, the controller unit including:
a communication component configured to communicate with a direct current charging device;
a controller configured to communicate with the direct current charging device via the communication component; and
a memory configured to communicate with the controller, the memory configured to store computer-executable instructions configured to cause the controller to:
determine a target location;
receive the identified location of the vehicle;
receive the state of charge information;
determine a charging request in response to the determined target location, the received location of the vehicle, and the received state of charge information; and
send, via the communication component, the determined charging request to the direct current charging device connectable to the vehicle.

10. The system of claim 9, wherein the memory is further configured to store computer-executable instructions configured to cause the controller unit to:
alter a previously-stored charge curve in response to the target location, the location information of the vehicle, and the state of charge information; and
include information from the altered previously-stored charge curve in the charge request.

11. The system of claim 10, wherein the memory is further configured to store computer-executable instructions configured to cause the controller to:
increase a charging current value at a time interval of the previously-stored charge curve.

12. The system of claim 10, wherein the memory is further configured to store computer-executable instructions configured to cause the controller to:
receive weather information; and
alter the previously-stored charge curve in further response to the received weather information.

13. The system of claim 10, wherein the memory is further configured to store computer-executable instructions configured to cause the controller to:
receive road condition information; and
alter the previously-stored charge curve in further response to the received road condition information.

14. The system of claim 10, wherein the road condition information is chosen from traffic information and road status information.

15. The system of claim 9, wherein the memory is further configured to store computer-executable instructions configured to cause the controller to:
receive route information; and
determine a location included in the received route information to be the target location, the location being chosen from a route waypoint and a route destination.

16. The system of claim 9, wherein the target location includes a home address associated with the vehicle.

17. A vehicle comprising:
a location sensor configured to identify location of a vehicle;
a battery;
a battery sensor configured to determine state of charge information of the battery; and
a controller unit configured to communicate with the location sensor and the battery sensor, the controller including:
a communication component configured to communicate with an external device;
a controller configured to communicate with the external device via the communication component; and
a memory configured to communicate with the controller, the memory configured to store computer-executable instructions configured to cause the controller to:
determine a target location;
receive the identified location of the vehicle;
receive the state of charge information;
determine a charging request in response to the determined target location, the received location of the vehicle, and the received state of charge information; and
send, via the communication component, the determined charging request to the external device connectable to the vehicle.

18. The vehicle of claim 17, wherein the memory is further configured to store computer-executable instructions configured to cause the controller unit to:
alter a previously-stored charge curve in response to the target location, the location information of the vehicle, and the state of charge information; and
include information from the altered previously-stored charge curve in the charge request.

19. The vehicle of claim 18, wherein the memory is further configured to store computer-executable instructions configured to cause the controller to:
increase a charging current value at a time interval of the previously-stored charge curve.

20. The vehicle of claim 17, wherein the target location includes a home address associated with the vehicle.
